(19) United States
(12) Patent Application Publication
(10) Pub. No.: US 2011/0181575 A1
(43) Pub. Date: Jul. 28, 2011

(54) Matrix-Addressable Display Device

(75) Inventors: David Sikharulidze, Bristol (GB); Tatiana Sikharulidze, Bristol (GB); Irakli Sikharulidze, Oxford (GB)

(73) Assignee: Hewlett-Packard Development Company, L.P.

(21) Appl. No.: 12/866,454

(22) PCT Filed: Feb. 26, 2008
(86) PCT No.: PCT/EP08/52321

§ 371 Date: Feb. 9, 2011

(51) Int. Cl. G09G 5/00; G09G 3/34

(52) U.S. Cl. 345/211; 345/107

(57) ABSTRACT

A matrix-addressable display device having a plurality of pixel areas (6) comprises two opposed cell walls (1) enclosing a layer of an electrophoretic composition (4) comprising a liquid crystal material having finely divided particles (5) dispersed therein. A plurality of row electrodes (3) are provided on an inner surface of one cell wall and a plurality of column electrodes (2) on an inner surface of the other cell wall. Each row electrode (3) intersects a column electrode (2) at an intersection area (10) within a pixel area (6) which is switchable from a first optical state to a second optical state by the application of a suitable electric pulse between the electrodes (2,3) at the intersection area. The intersection area (10) is smaller than the pixel area (6). Each electrode (2,3) is made of metal.

The present invention relates to a matrix-addressable display device, notably to an electrophoretic effect based display device suitable for passive matrix addressing.

A passive matrix addressed display typically comprises a pair of opposed substrates provided with row and column striped transparent electrodes, on their inner surfaces. Sandwiched between the substrates is an electro-optical medium, capable of switching optical properties under an applied electric field.

The intersections of row and column striped transparent electrodes, between which is placed the electro-optical medium, define the pixels array. The formation of a whole image is achieved by multiplexing addressing, enabling the switching of the whole screen during scanning row by row and sending data voltage through column electrodes for each electrically selected row electrode. Due to threshold behaviour of the electro-optical medium, only the selected pixels along row electrodes, which are under combination of row selected pulse and column data voltage, will be switched. So the whole image will be built during repeating of this process for each row electrode

Electrophoretic effect based display devices typically comprise a pair of opposed substrates provided with transparent electrode patterns on their inner surfaces. Sandwiched between the substrates is a non-conductive liquid in which is dispersed highly scattering or absorbing microparticles. The microparticles become electrically charged, and can be reversibly attracted to the top or lower surface of the display by application of a suitable electrical field across the electrode structures. The optical contrast is achieved by contrasting of colours of the pigments with dye doped liquids or by contrasting colours of oppositely charged dual pigments, suspended in a transparent liquid. A problem with such displays is that they lack threshold, i.e. the particles begin to move at a low voltage, and move faster as a higher voltage is applied. This makes the technology unsuitable for conventional multiplexed (matrix-addressed) displays, which require a relatively sharp threshold to reduce crosstalk.

In US 2005/0094087, which is owned by the present assignee and the contents of which are hereby incorporated by reference in their entirety, a bistable electrophoretic liquid crystal display is described, which allows switching with threshold and video rate. This uses overlapping transparent X-Y electrodes which enable matrix addressing.

In such displays, with far/near switching, the pixel is defined by the area of transparent electrodes, via which an electric field is applied to the pixel.

Transparent electrodes attenuate transmitted light, which limits the brightness. The transparent electrodes also have high resistivity, which can limit the size of a simple passively addressed display. The brightness of electrophoretic displays can be improved by the use of in-plane electrodes, for example provided by two strip electrodes on the same substrate, between which the pigments move horizontally under an applied electric field. In such construction the liquid medium is transparent, without a dye, and provides a good stability of the mixture with suspended pigments. US 2005/0275933 describes such an electrophoretic device, which has a substrate with in-plane electrodes and an opposite substrate which is free of electrodes. Simple passive matrix addressing is difficult to achieve for a device of this construction.

U.S. Pat. No. 4,648,956 describes an electrophoretic display in which one substrate has single pixel transparent display electrodes and the opposite substrate has strip collecting electrodes. Under an applied voltage the pigments cover the whole pixel area with transparent single display electrodes and the device is in an OFF state. Applying a suitable different voltage causes collection of the pigments on the strip collecting electrodes on the opposite side in such a manner that the spacing between the strip electrodes is transparent. The light passes through the pixel, and accordingly this determines the device's ON state.

In U.S. Pat. No. 7,264,851, which is also owned by the present assignee, a bistable electrophoretically controlled nematic liquid crystal display is described. This uses a liquid crystal with suspended solid nanoparticles and overlapping transparent X-Y electrodes which enable matrix addressing. The bistable switching between optically different states of LC is achieved by the polarity controlled electrophoretic motion of the nanoparticles, which stabilises alignment of LC in switched states. Typically the size of intersection of row and column transparent electrodes determines the size of switched pixel, providing an optical effect.

Bistability enables switched pixels to be held at zero field indefinitely, until changed by application of a suitable electrical signal. Because of the bistability, passive matrix addressed displays enable, in principle, infinite multiplexing. This means, potentially, for such displays no limitation of the number of multiplexed pixels and, consequently, the size of displays.

However, the transparent conductive layer of the display pixels reduces transmittance of the display, and resistivity, which becomes significant for long strip of transparent electrodes, limits passive matrix addressing of large area displays.

### SUMMARY OF THE INVENTION

Aspects of the invention are specified in the independent claims. Preferred features are specified in the dependent claims.

The invention uses as row and column electrodes metallic fine lines which have high conductivity and consequently allow the fabrication of large scale passive matrix addressed displays. The switched pixel area is much bigger than the metallic line intersection area and it may be observed directly under bare transparent film, which improves display brightness. The invention enables the design of a full colour display with stacked layers.

The invention will now be further described, by way of example only, with reference to the following drawings.

### BRIEF DESCRIPTION OF THE DRAWINGS

FIG. 1 shows a schematic side view and plan view of a display device in accordance with an embodiment of the invention;

FIGS. 2 and 3 are views corresponding to those of FIG. 1, showing the device in two different optical states;

FIG. 4 shows plan views of substrates for a device in accordance with an embodiment of the invention;

FIG. 5 shows plan views of part of a display device in accordance with another embodiment of the invention;

FIG. 6 shows plan views of a display device including the substrates of FIG. 4;

FIG. 7 shows photographs of the display of FIG. 6 in two different optical states;

FIGS. 8-10 show views corresponding to FIGS. 4,6 and 7, of a device in accordance with a further embodiment of the invention;

FIG. 11 illustrates switching in a device in accordance with an embodiment of the invention;

FIG. 12 is a schematic side sectional view of a pixel of the device of FIG. 1 showing field force lines; and

FIG. 13 shows switching of a pixel in a display in accordance with a further embodiment of the invention, with two oppositely charged colours of pigment particles.

### DETAILED DESCRIPTION

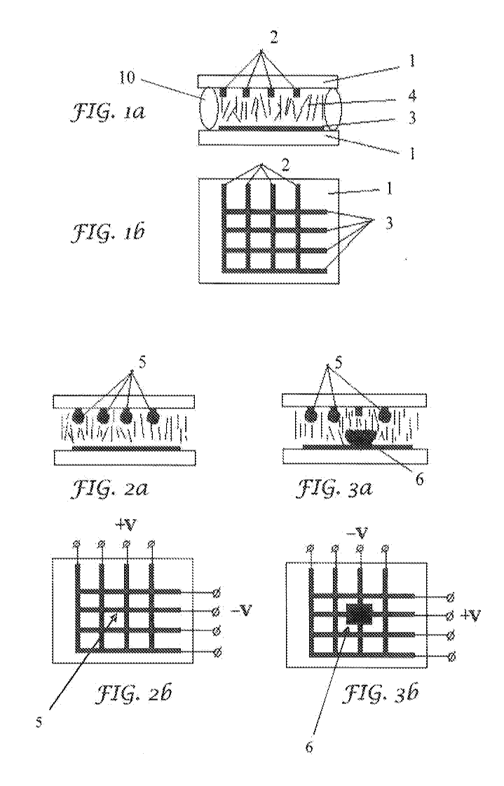

The matrix-addressable display device shown in FIGS. 1-3 comprises two opposed cell walls 1 enclosing a layer of an electrophoretic composition 4. The electrophoretic composition 4 comprises a liquid crystal material having finely divided particles 5 dispersed in it. In this example the particles 5 are pigment particles. An inner surface of one cell wall carries a plurality of column (Y) electrodes 2 and an inner surface of the other cell wall carries a plurality of row (X) electrodes 3. The cell walls 1 are spaced apart in a manner well known per se, with spacer beads 10.

The row and column electrodes are fine metal lines, preferably having a width less than about 5 μm. The lines 2,3 of the assembled XY matrix are normal to each other and suitable for conventional passive matrix addressing. Switching of the device is controlled by applying a voltage to the column electrodes 2 and row electrodes 3. A unipolar pulse with suitable amplitude and duration causes collection of the particles 5 around the column electrodes 2, on the top substrate in this example. In this first optical state (FIG. 2a) the area between the electrodes transmits light. An electric pulse with opposite polarity and lower voltage or shorter pulse length provides switching to a second, very different, optical state (FIG. 2b). In this second optical state, the pigment particles 5 are spread in the pixel area 6 around the intersection of a row and column electrode and transmission of light in this pixel area is blocked. The pixel area 6 (in plan view) is substantially greater than the intersection area of the electrodes 2,3 within it.

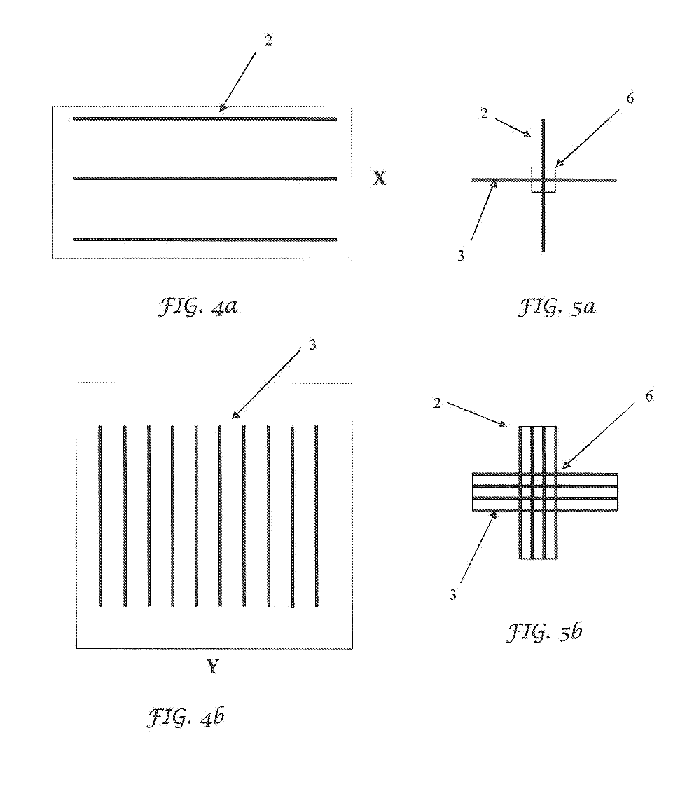

Without wishing to be bound by theory, we consider that the switching may be explained by the distribution of an electric field 9 around the intersection area 10 of the fine conductive lines, which are shown very approximately in FIG. 12. The electric field distribution area, which determines the pixel area 6, is much greater than the intersection area 10. Therefore, when a pulse of quite long duration and suitable voltage is applied to the XY lines, the pigment particles 5 move in the area with an electric field and (due to the long pulse time) they eventually will be collected around the line 2 on the opposite substrate (in the present example). The opposite pulse with shorter duration or lower voltage will provide migration of the pigment particles in the opposite direction. Because of the short pulse the pigment particles will stop movement in some area outside the intersection of the fine lines 2,3. In other words, the pigment particles 5 will spread in the pixel area 6, substantially wider than the intersection area. Consequently, the transmittance of this area will be reduced and light will be blocked (FIG. 3).

Such switching is available because of the electrophoretic effect in the LC material. In US 2005/0094087, the entire contents of which are incorporated herein by reference, it was shown that an electrophoretic effect in an LC medium enables bistable switching, threshold and fast speed. Importantly, this effect is characterised by high stability and provides a good memory effect. In the present case, for the memory effect, the pigment particles 5 do not need to be stacked on an electrode surface as in a conventional device with isotropic liquids. Elasticity of the LC and strong interaction between LC molecules and pigment particles provides a well memorised state at zero field. This capability of the electrophoretic effect in an LC medium is a principal point, allowing operation of the presented device.

FIG. 4 shows XY electrode configurations for an experimental cell. The X electrode substrate (FIG. 4a) and Y electrode substrate (FIG. 4b) have parallel metallic lines with different spacing. For optimal distribution of an electric field and uniform spreading of the pigment particles in a pixel area 6, the pixel can be formed with a few shorted XY lines (FIG. 5). This makes the pixels 6 bigger and reduces the number of addressed lines. The linear dimension of a pixel, enabling full switching of the pixel area is about 30-60 μm. Consequently the working area of such a display with 1000 single lines will be about 6 cm. So, when a few lines are shorted, it will give a bigger pixel and a bigger working area of the display. For example, four shorted lines will give the pixel 4×60 μm=240 μm. Consequently the display with 1000 lines will have a 24 cm working area.

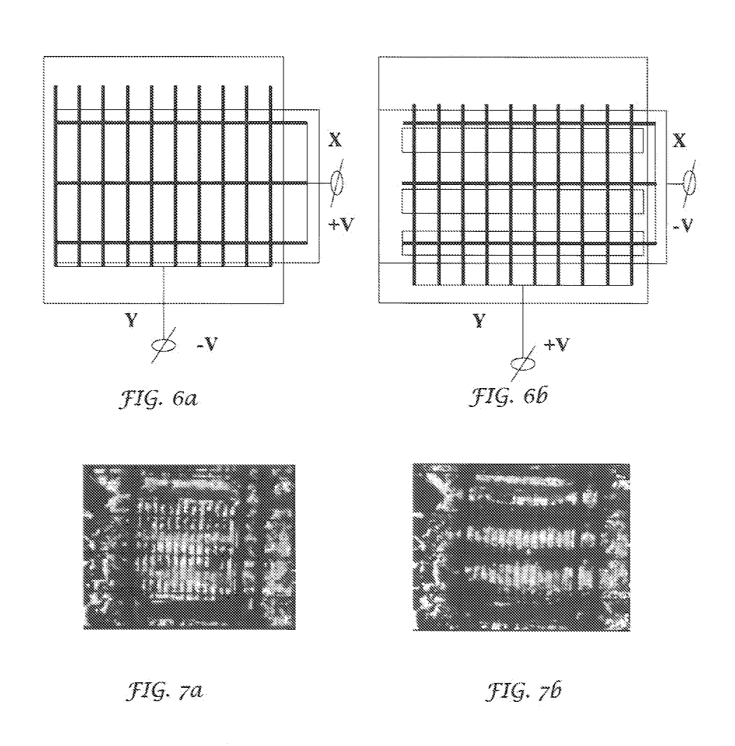

The substrates of FIG. 4 are used in the experimental device shown in FIG. 6. The width of the electrodes is about 10 μm. The spacing between electrodes on the X substrate is about 300 μm and the spacing in the Y substrate is about 30 μm. The electrode lines of the assembled XY matrix cell are normal to each other. The cell is filled with MLC6436-000 nematic LC (Merck) containing 15% TiO₂ pigment particles of primary size 340 nm. The thickness of the cell is defined by 10 μm polymer spacer beads, embedded in the electrophoretic mixture. To the cell are applied unipolar pulses of duration 20-100 ms and amplitude 80-150 V. In this experiment, the electrode lines on the X and Y substrates are shorted.

FIG. 7 shows transmittance of the cell in different switched states. The transmissive state (FIG. 7a) is achieved under applied pulses of 80 V amplitude and 50-60 ms duration. Switching to the light blocking state (FIG. 7b) is provided by pulses of opposite polarity and shorter duration (20-30 ms). The pictures show localised switching along the X lines but substantially complete switching along the Y lines. This can be explained by the different spacing between X and Y electrodes. Y electrodes have shorter spacing (30 μm) and electrical field distribution outside of the intersection area has the same dimension and covers the spacing area. Consequently the pigment particles under a suitable applied field are capable of spreading in this area. On the other hand, the spacing between X lines is much wider (about 300 μm) and we can suppose that the electric field does not cover this distance, which limits the migration distance of the pigment particles.

A relationship between voltage and pulse and migration distance can be expressed as:

t=L²/μU, where L is migration distance, μ is mobility of the particles, U is voltage and t is drifting time (ie duration of the pulse).

If we assume that mobility ˜5.10⁻⁶ cm²/Vs,

From L²=μUt, if pulse length t=5 ms, U=40 V, particles will move in the distance d˜30 μm.

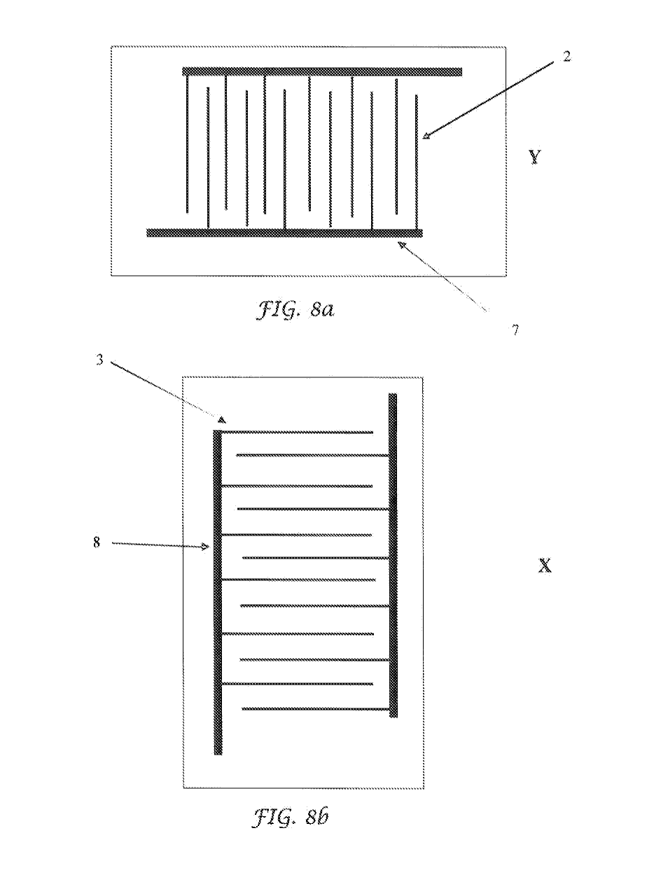

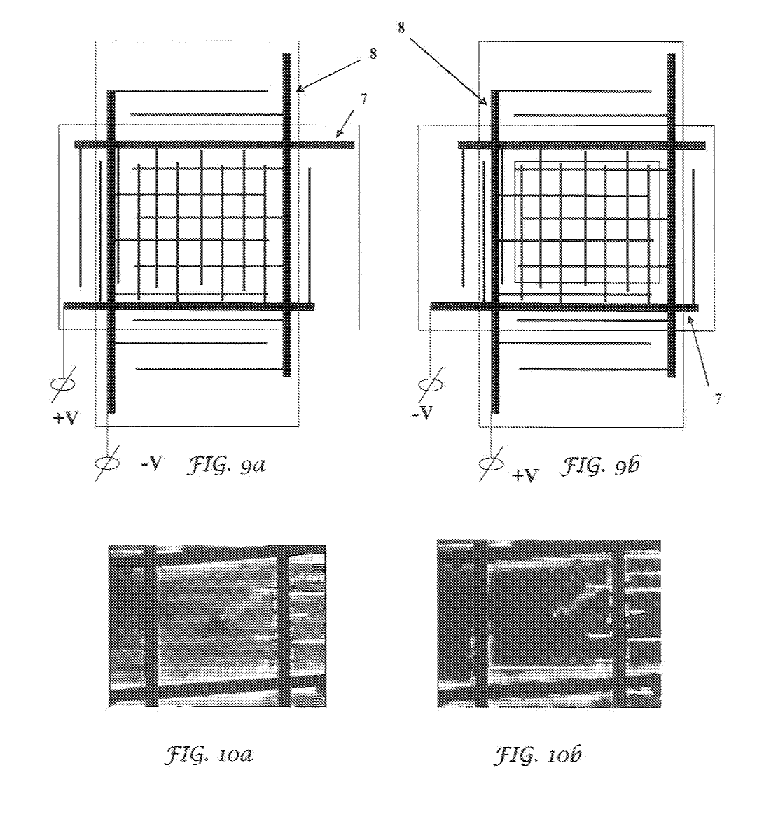

To investigate the correctness of this hypothesis, we have experimented with using two substrates with identical interdigitated metallic electrode lines 2,3 (FIGS. 8-9). Alternate column electrodes 2 are connected together by a column busbar 7 and alternate row electrodes 3 are connected together by a row busbar 8. The width of each electrode 2,3 is 2 μm and the interelectrode spacing is 10 μm. The cell is assembled in the same manner as the previously-described cell.

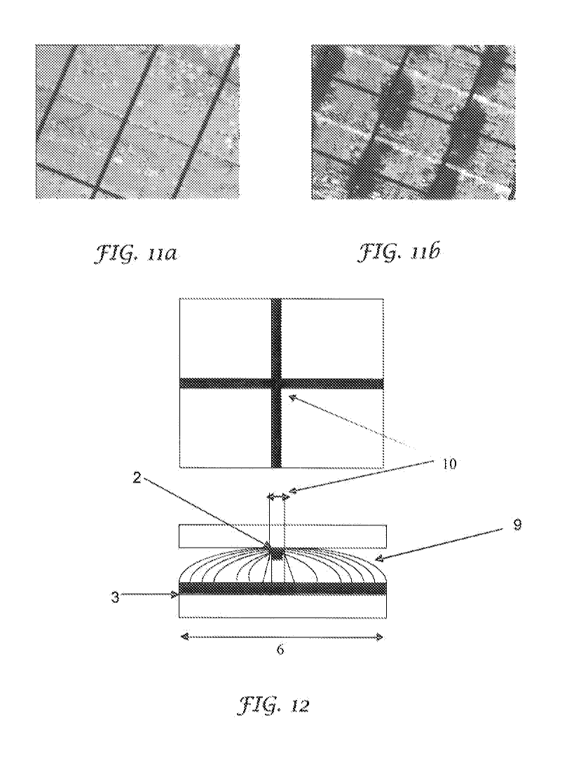

FIG. 10 shows the switching in the cell. In this case, switching is observed in the full area because the spacing in the XY direction is equal and the electric field fully covers this distance and effectively spreads the pigment particles around symmetrically around the intersections of the XY electrodes.

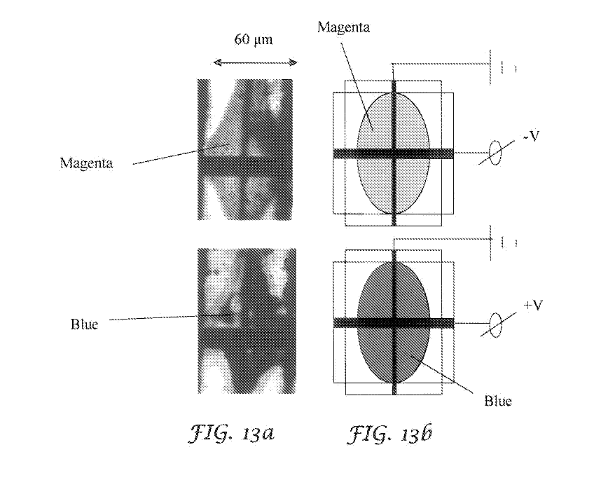

Use of two colour oppositely charged pigments allows realization of the display, which switches between two colours. FIG. 13 shows the switching in a cell which is filled with LC MLC6681, containing 3% transparent pigment Hostaperm Blue B2G-D, acquiring negative charge, and 3% transparent pigment Hovoperm Magenta E02, acquiring positive charge. A 10 μm cell thickness is provided by polymer spacer beads embedded in the mixture. The pigment particle s exhibit different charge and mobility, which gives the possibility to control switching by applying electrical pulses with different polarity and amplitude/length value. For one polarity the blue pigment is spread in the pixel area, and magenta pigment particles are collected around a metallic line, and consequently the pixel becomes blue. The opposite polarity pulse with different amplitude/length produces a collection of the blue pigments around a metallic line and spreads magenta pigment particles in the pixel area. Consequently the pixel switches to magenta colour. Photomicrographs of the two optical states are shown in FIG. 13a, and the switching is schematically represented in FIG. 13b.

Stacking of two layers with such dual pigments with suitable colours, blue-magenta in one layer and yellow-black on second stacked layer, enables switching with full colour.

The same switching effect is observed in a similar cell which is filled with an electrophoretic composition comprising a nematic LC and small size nanoparticles (primary size 7-40 nm). In this case the nanoparticles do not produce an optical effect but they stabilise the switched state of the LC host, which produces an optical effect. FIG. 11 shows the switching, observed in a hybrid-aligned nematic (HAN) cell using MLC6204-000 with 3% silica nanoparticles R812 (primary size 7 nm). The thickness was defined using 5 μm polymer beads. The cell was driven with 80 V pulses, with durations of 20-40 ms and 5-10 ms. The cell is placed between crossed polarisers and turned at 45° to the polarisers' axes for maximum contrast. The light state (FIG. 11a) is achieved by application of a 20-40 ms pulse, under which the nanoparticles are collected around the electrode lines. Under the shorter pulse the nanoparticles will be spread in the area around the intersection of the metallic lines; this state supports a vertical alignment of the LC molecules, which is observed as a dark state between crossed polarisers (FIG. 11b). To provide appropriate optical switching in such a cell, the surfaces of substrates with electrodes can be treated for planar, homeotropic or hybrid alignment of LC molecules.

Direct observation of optical effect with high brightness is achieved in a similar cell, which used dye doped LCs. Depending on the dye colour, the display provides switching between an uncoloured transparent state and a colour state, controlled by the nanoparticles stabilisation effect.

For a colour effect, for example, the LC MLC 6436-000 with 3% silica nanoparticles R812 (primary size 7 nm), was doped with 1-3% magenta dye G471, cyan dye G472 or yellow dye G232 (from Hayashibara Biochemical Laboratories, Inc), which, accordingly, allows displays with magenta, cyan and yellow colours.

The following were used in formulating experimental cells in accordance with embodiments of the invention:

nematic LCs: with positive dielectric anisotropy MLC6881, MLC6650, MLC6639, MLC6204-000, MLC6436-000, E7, E63, ZLI2293, dyed black LCs ZLI4756/2, ZLI4727, ZLI4714/3 (all from Merck); negative dielectric anisotropy LCs ZLI4788-000, MDA-03-4517, MDA-03-4518;
white pigments: TiO₂ R700, R900 (Dupont), WP-10S (Catalysts & Chemical Ind. Co. Ltd);
coloured iron oxide pigments RP-10S(red), BP-10S(black), DP-10S(yellow) (Catalysts & Chemical Ind. Co. Ltd); transparent pigments Hostaperm Blue B2G-D, Hostaperm Magenta E02, Novoperm Yellow 4G (Clariant);
nanoparticles: Aerosil R812, R106, R974, R972, R104, R504, A380, OX50, Aeroxide Alu C (Degussa Huls).

In an alternative embodiment, transparent coloured pigment particles may be used, and three layers, CMY, may be stacked to provide a full colour transmissive display with passive matrix addressing.

The invention uses as row and column X-Y electrodes metallic fine lines, notably lines of width less than about 5 μm) which have high conductivity and consequently allow the fabrication of large scale passive matrix addressed displays. The switched pixel area is much bigger than the metallic line intersection area and it may be observed directly under bare transparent film, which improves display brightness. Switching between optically transparent states and OFF-states enables the design of a full colour display with stacked layers.

The articles ‘a’ and ‘an’ are used herein to denote ‘at least one’ unless the context otherwise requires.

1. A matrix-addressable display device having a plurality of pixel areas, the device comprising:
two opposed cell walls enclosing a layer of an electrophoretic composition comprising a liquid crystal material having finely divided particles dispersed therein;
a plurality of row electrodes on an inner surface of one cell wall and a plurality of column electrodes on an inner surface of the other cell wall; wherein
each row electrode intersects a column electrode at an intersection area within a pixel area which is switchable from a first optical state to a second optical state by the application of a suitable electric pulse between the electrodes at the intersection area, said intersection area being smaller than the pixel area; and wherein
each electrode is made of metal.

2. A device according to claim 1, wherein each electrode has a width, and is spaced apart from a neighbouring electrode by a distance greater than two times said width.

3. A device according to claim 1, wherein each electrode has a width, and is spaced apart from a neighbouring electrode by a distance greater than five times said width.

4. A device according to claim 1, wherein each electrode has a width of 10 μm or less.

5. A device according to claim 1, wherein each electrode has a width in the range 1 to 5 μm.

6. A device according to any preceding claim, wherein the spacing between adjacent electrodes is in the range 2 to 300 μm.

7. A device according to any preceding claim, wherein the spacing between adjacent electrodes is in the range 20 to 100 μm.

8. A device according to any preceding claim, wherein the device further comprises:
a plurality of X line driving circuits and a plurality of Y line driving circuits, said plurality of X and Y line driving circuits respectively connected to said plurality of row electrodes and said plurality of column electrodes so that the simultaneous application of suitable electric potentials to a row electrode and a column electrode will cause a threshold voltage of a predetermined value to be applied across the electrophoretic composition between said electrodes.

9. A device according to any preceding claim, wherein the particles have a size in the range 1 to 1000 nm.

10. A device according to any preceding claim, wherein the particles have a size in the range 5 to 50 nm.

11. A device according to any preceding claim, wherein the particles are present in a concentration of from 0.1% to 50% by weight of the liquid crystal material.

12. A device according to claim 11, wherein the particles are present in a concentration of from 1 to 15% by weight of the liquid crystal material.

13. A device according to claim 11, wherein the particles are present in a concentration of from 1 to 5% by weight of the liquid crystal material.

14. A device according to any of claims 9-13, wherein the liquid crystal material is switchable between two optically distinct states and wherein the particles function to stabilise the liquid crystal material in at least one of said states.

15. A device according to claim 1, wherein the particles are pigment particles which will absorb at least some wavelengths of visible light.

16. A device according to claim 15, wherein the pigment particles are transparent and transmit visible light which is not absorbed.

17. A device according to any preceding claim, wherein at least some adjacent electrodes on a cell wall are shorted to provide a larger pixel area.

18. A device according to claim 17, wherein at least some adjacent electrodes on each cell wall are shorted.

19. A colour display apparatus comprising a plurality of devices according to claim 16 arranged in a stack, the pigment particles transmitting different wavelength ranges of light in each device.

20. Apparatus according to claim 19, comprising three devices, each transmitting a different one of cyan, magenta and yellow light.
